(19) United States
(12) Patent Application Publication
(10) Pub. No.: US 2004/0145989 A1
(43) Pub. Date: Jul. 29, 2004

(54) Recording medium and writing device

(75) Inventors: Naoki Kusunoki, Kanagawa (JP); Setsuji Tatsumi, Kanagawa (JP); Kanji Nagashima, Kanagawa (JP); Seiichiro Oku, Kanagawa (JP); Yoshiro Yamazaki, Kanagawa (JP); Toshiya Kojima, Kanagawa (JP); Seiichi Inoue, Kanagawa (JP); Kenichi Kodama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/706,287

(22) Filed: Nov. 13, 2003

(30) Foreign Application Priority Data
Nov. 14, 2002 (JP) 2002-330748

(51) Int. Cl. G11B 7/00

(52) U.S. Cl. 369/53.22; 369/275.3

(57) ABSTRACT

A recording medium is structured by a recording layer, which is for storing storage data, and an indication layer, which is for indication information used for identifying the storage data, being laminated together. Writing and deletion are possible at the indication layer. A PC generates inputted storage data and indication information for identifying the storage data, and transmits them to a writing/reading device. The writing/reading device writes the storage data and the indication information to the recording medium. The storage data is written at the recording layer, and the indication information is written at the indication layer. The storage data stored at the recording medium can be easily and correctly grasped.

### CROSS-REFERENCE TO RELATED APPLICATION

This application claims priority under 35 USC 119 from Japanese patent Application No. 2002-330748, the disclosure of which is incorporated by reference herein.

### BACKGROUND OF THE INVENTION

1. Field of the Invention

The present invention relates to a writing device or a writing/reading device, and in particular, to a writing and writing/reading device for CD-RWs, DVDs, and the like.

2. Description of the Related Art

Conventionally, non-volatile memories such as CD-RWs, DVDs, and the like have been known as writable recording media. Usually, a dedicated reader/writer is used for writing data onto these recording media. A CD drive built-in in a personal computer (hereinafter called a “PC”), a CD drive externally connected via a cable to a PC, a DVD drive, and the like are used as such a reader/writer (hereinafter called an “R/W”). Further, the contents of the data written to such a recording medium can be confirmed by using the aforementioned dedicated R/W.

In order to confirm, at the recording medium itself, the contents of the data written thereto, a technique has been proposed of printing out the contents of recording medium on a label seal (refer to, for example, Japanese Patent Application Laid-Open (JP-A) No. 2000-132946, pp.3-4, FIG. 1). In accordance with such a technique, if the printed label seal is affixed to the recording medium, it is possible to confirm the data recorded on the recording medium by only the recording medium, without loading the recording medium into a dedicated R/W.

However, in the above-described technique, after the label seal, on which the contents of the recording medium are printed, is affixed to the recording medium, if the contents of the recording medium change, there are cases in which the contents printed on the label seal and the contents of the recording medium do not match.

### SUMMARY OF THE INVENTION

The present invention was developed in order to overcome the above-described drawback, and provides a writing/reading device which can ensure the reliability of indicated contents of an indication medium which is provided at a recording medium and which indicates the contents of the recording medium.

In order to achieve the above object, a first aspect of the present invention is a recording medium comprising a storage layer for storing data, and an indication layer for providing indication information relating to the stored data, wherein the indication information can be written at the indication layer, and at least a portion of the indication information which has been written can be rewritten.

The recording medium of the first aspect of the present invention is structured to have a storage layer and an indication layer. The storage layer is for storing storage data. The indication layer is for displaying indication information which relates to the storage data. Indication information can be written to the indication layer, and at least a portion of the written indication information can be rewritten.

Accordingly, the recording medium can store storage data at the storage layer, and can display, at the indication layer, indication information relating to the storage data. Thus, the storage data can be confirmed by looking at the indication information. Further, the indication layer is such that at least a portion of the indication information written at the indication layer can be rewritten. Therefore, in cases such as when the storage data is changed or the like, the written indication information can be changed.

Further, the indication layer of the recording medium of the present aspect can be structured by electronic paper. As is well known, electronic paper is thin. Therefore, the recording medium can be formed having a thickness which is only minutely increased from the thickness of the storage layer, and it is possible to provide a recording medium which is easy to handle.

A second aspect of the present invention is a data writing device writing data to a recording medium having a storage layer for storing data, and an indication layer for providing indication information relating to the stored data, the device comprising: a storing section storing data at the storage layer of the recording medium; and a writing section writing, at the indication layer, indication information which relates to the stored data and which is for indication at the recording medium.

The writing/reading device of the above-described aspect of the present invention has a storing section which stores storage data at the storage layer of the recording medium. The indication information relating to the storage data is written at the indication layer of the recording medium by the writing section. Further, at least a portion of the indication information which has been written at the indication layer can be rewritten by the writing section.

Accordingly, the writing/reading device of the present invention can store storage data at the storage layer of the recording medium, and can write indication information relating to the storage data at the indication layer of the recording medium. No lack of correspondence between the storage data and the indication information arises, and the reliability of the contents indicated by the indication information written at the indication layer can be ensured.

The storing section can further store the indication information at the storage layer. In this way, if the indication information is stored at the storage layer of the recording medium together with the storage data, the indication information can be easily grasped by reading the indication information stored at the storage layer.

Further, when an updating processing such as writing or deleting or the like is carried out with respect to the storage data written at the storage layer of the recording medium, there are cases in which the contents of the changed storage data and the indication information displayed at the indication layer become unrelated.

Thus, the writing/reading device of the present invention has a detecting section which detects the difference between the storage data, which is stored at the storage layer of the recording medium, and the storage data which is to be subsequently stored; and a generating section which, on the basis of the results of detection of the detecting section, generates storage data (difference storage data) regarding the difference with respect to the storage data which has already been stored, and generates indication information (difference indication information) regarding the difference with respect to the indication information. The storing section can store the storage data regarding the difference at the storage layer, and the writing section can write the indication information regarding the difference at the indication layer.

The detecting section detects the difference between the already-stored storage data stored in the recording medium, and the storage data which is to be subsequently stored. This difference corresponds to, for example, the place to be changed and the contents of the change of the storage data. The place to be changed and the contents of the change are generated by the generating section. The storing section stores the generated storage data regarding the difference in the storage layer, and the writing section writes the indication information regarding the difference at the indication layer. The place to be changed and the contents of the change are thereby reflected in the storage layer and the indication layer of the recording medium. Accordingly, accompanying the updating of the storage data, it is possible to change the indication information to contents corresponding to the updated storage data. Therefore, the reliability of the indicated contents of the indication medium can be ensured.

The storing section can further store the indication information regarding the difference at the storage layer. Therefore, accompanying the updating of the storage data, the indication information stored in the storage layer can be updated.

Further, when updating of the storage data is carried out, in order to detect the difference between the storage data already stored and the updated storage data, the storage data which has already been stored at the storage layer of the recording medium must be grasped. Here, if the writing device of the present invention is further provided with a data memory section which stores the storage data and the indication information, the storage data which has already been stored can be read from the memory section. Therefore, there is no need to read the storage data out from the recording medium. Further, if the history is stored each time updating is carried out, it is possible to manage the histories of the storage data and the indication information stored in the past.

Further, the indication layer of the recording medium of the present invention can be structured by electronic paper. As is well known, electronic paper is thin. Therefore, the recording medium can be formed having a thickness which is only minutely increased from the thickness of the storage layer, and it is possible to provide a recording medium which is easy to handle.

### BRIEF DESCRIPTION OF THE DRAWINGS

FIG. 1 illustrates the overall structure of a writing/reading system relating to an embodiment.

FIG. 2 illustrates an example of a cross-sectional view of a recording medium relating to the embodiment.

FIG. 3 is a block diagram showing the main structures of the writing/reading system relating to the embodiment.

FIG. 4 is a flowchart showing the flow of processings of a PC in the writing/reading system relating to the embodiment of the present invention.

FIG. 5 is a flowchart showing the flow of processings of a writing/reading device in the writing/reading system relating to the embodiment of the present invention.

FIG. 6 is a schematic diagram showing an example of indication information displayed at the recording medium relating to the embodiment of the present invention.

FIG. 7 is a schematic diagram for explaining a difference extraction process at a time of updating the indication information and storage data stored in the recording medium relating to the embodiment of the present invention.

### DETAILED DESCRIPTION OF THE INVENTION

An embodiment relating to the writing/reading device of the present invention will be described on the basis of the drawings. In the present embodiment, the present invention is applied to a writing/reading system formed by a personal computer (hereinafter, “PC”) and a writing/reading device.

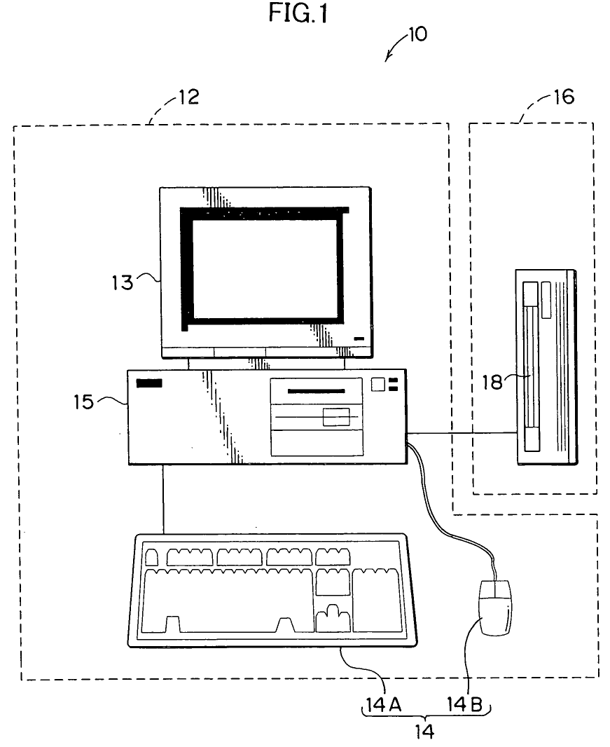

FIG. 1 shows the overall structure of the writing/reading system relating to the present embodiment. In the present embodiment, a writing/reading system 10 is structured by a PC 12 and a writing/reading device 16. The PC 12 and the writing/reading device 16 are connected to one another via a cable, such that they can transmit and receive data and commands to and from one another.

The PC 12 is for a user to operate in order to write, to a recording medium 18 which will be described later, storage data to be stored in the recording medium 18 and indication information which indicates the contents of the storage data and which will be described later. The PC 12 is structured by an input device 14, a display device 13, and a main body 15. The main body 15 mainly carries out control of the receipt and transmission of data and commands from and to the writing/reading device 16. The input device 14 is for a user to carry out input of various types of designations with respect to the main body 15. In the present embodiment, a keyboard 14A and a mouse 14B function as the input device 14. The display device 13 is for the display of various types of designation menus and the like. Examples of the display device 13 are an LCD, a CRT, and the like. The writable recording medium 18 can be loaded into the writing/reading device 16. The writing/reading device 16 is mainly for carrying out, on the recording medium 18 loaded therein, processings such as the writing of storage data (which will be described later) and indication information (which will be described later), the reading of the storage data stored in the recording medium 18, and the like.

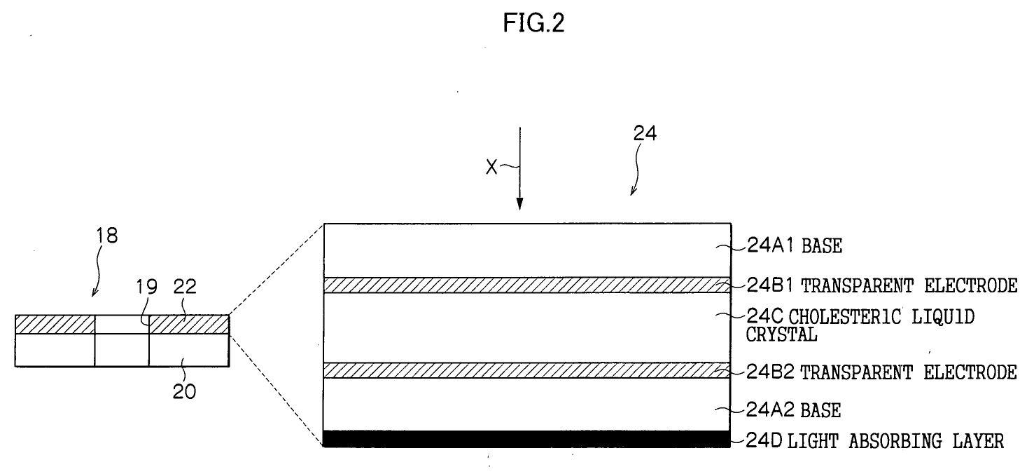

Examples of the recording medium 18 are CD-Rs, CD-RWs, DVDs, and the like. FIG. 2 illustrates an example of a cross-sectional view of the recording medium 18. The recording medium 18 is structured by an indication layer 22 being laminated on a recording layer 20 at which data can be rewritten by light or magnetism. The indication layer 22 is for displaying the indication information which expresses the contents of the storage data stored in the recording layer 20. The indication layer 22 is formed in the shape of a sheet, and is an indication medium such as so-called electronic paper which is rewritable. The indication information displayed at the indication layer 22 can be visually perceived. Examples of the indication layer 22 are heat recording media at which data is recorded and deleted by a heat treatment, optical recording media at which data is recorded and deleted by an optical treatment (i.e., the irradiation of light), ink recording media at which data is printed or deleted by the addition of ink or the addition of white ink, and the like.

In the present embodiment, an optical recording medium is used as the recording medium 18 in order to achieve the present invention. As one example thereof, the technique shown in FIG. 2 is known. In this case, as shown in an enlarged cross-sectional view 24 of the indication layer 22 which serves as an optical recording medium, the indication layer 22 is structured such that a pair of a transparent electrode layer 24B1 and a transparent electrode layer 24B2, which are sandwiched between a base 24A1 and a base 24A2 on a light absorbing layer 24D, and a cholesteric liquid crystal layer 24C sandwiched between the transparent electrode layer 24B1 and the transparent electrode layer 24B2, are laminated together. In accordance with this indication layer 22, in a state in which light is irradiated thereon from direction X, due to the application of pulse voltage between the transparent electrodes 24B1, 24B2, the orientation of the liquid crystals of the cholesteric liquid crystal layer 24C changes. Due to this change, color light corresponding to the helical pitch of the liquid crystals can be selectively reflected, such that indication/non-indication of data can be realized by the light absorbing layer 24D.

Note that the recording medium 18 corresponds to the recording medium of the present invention, the recording layer 20 corresponds to the storage layer of the present invention, and the indication layer 22 corresponds to the indication layer of the present invention.

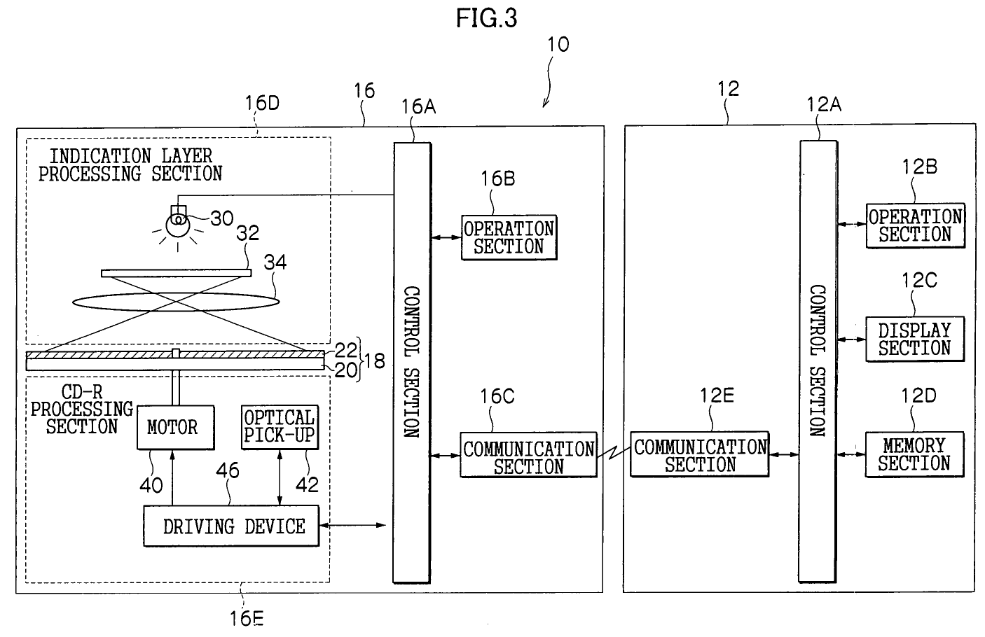

In FIG. 3, the main structures of the writing/reading system 10 relating to the present embodiment are shown in a block diagram. The PC 12 is structured by a control section 12A, an operation section 12B, a display section 12C, a memory section 12D, and a communication section 12E. The control section 12A is structured so as to include an unillustrated microcomputer. The control section 12A is connected respectively to the operation section 12B, the display section 12C, the memory section 12D, and the communication section 12E, such that transmission and receipt of data and commands between the control section 12A and these respective sections is possible.

The control section 12A is a functional section mainly carrying out creation of, instruction of the writing of, and the like of write data (which will be described later) with respect to the recording medium 18 which is loaded in the writing/reading device 16. The control section 12A includes an unillustrated memory in which a processing routine, which will be described later, is stored. The control section 12A is structured by a microcomputer formed by a CPU, a ROM, and a RAM (none of which is illustrated). Note that the processing routine may be stored in the unillustrated ROM or RAM. Further, the processing routine may be stored in the memory section 12D which will be described later.

The display section 12C is for displaying write data (which will be described later), various types of input items, and the like. The display device 13 functions as the display section 12C. The operation section 12B is for inputting instructions at the PC 12. The input device 14 functions as the operation section 12B. The memory section 12D is for storing write data (which will be described later), memory data (which will be described later) for specifying portions to be changed, and the like. The communication section 12E is for transmitting to or receiving from the writing/reading device 16, various types of data such as the write data (which will be described later), various types of instructional commands, and the like. The communication section 12E includes an unillustrated interface function for transmitting and receiving data to and from the writing/reading device 16 by a wire (such as a cable or the like) or in a wireless manner.

The writing/reading device 16 is structured by a control section 16A, an operation section 16B, a communication section 16C, an indication layer processing section 16D, and a CD-R processing section 16E. The control section 16A is structured so as to include an unillustrated microcomputer. The control section 16A is connected respectively to the operation section 16B, the communication section 16C, the indication layer processing section 16D, and the CD-R processing section 16E, such that transmission and receipt of data and commands between the control section 16A and these respective sections is possible.

The control section 16A is a functional section which mainly carries out control of the indication layer processing section 16D and the CD-R processing section 16E, in accordance with instructions from the PC 12 and with respect to the recording medium 18 loaded in the writing/reading device 16. The control section 16A includes a memory (not shown) in which a processing routine, which will be described later, is stored. The control section 16A is structured by a microcomputer formed from a CPU, a ROM, and a RAM (none of which is illustrated). Note that the processing routine may be stored in the unillustrated ROM.

The operation section 12B is for inputting instructions such as instructions to load or remove the recording medium 18 to be loaded in the writing/reading device 16, or the like. The communication section 16C is for receiving and transmitting, from and to the PC 12, various types of data such as write data (which will be described later), various types of instructional commands, and the like. The communication section 16C includes an unillustrated interface function for transmitting and receiving data to and from the PC 12 by a wire (such as a cable or the like) or in a wireless manner.

The indication layer processing section 16D is for writing indication information to the indication layer 22 of the recording medium 18. The indication layer processing section 16D is structured by a light source 30, a switching element 32 such as a liquid crystal or the like, and an image pick-up lens 34. The light source 30 and the switching element 32 are connected to the control section 16A, such that the transmission and receipt of data and commands therebetween is possible. The switching element 32 is for the display of data received from the control section 16A. The light source 30 is for projecting an optical pattern of the image displayed on the switching element 32, onto the indication layer 22 and via the lens 34 and in accordance with the control of the control section 16A. The optical image of the projected image is optically written onto the indication layer 22. This optical writing is carried out as follows for example: when voltage is supplied from an unillustrated voltage application section to the indication layer 22 and light is irradiated in the form of an image, indication information, which can be visually perceived, is displayed on the indication layer 22 in accordance with the image pattern.

The CD-R processing section 16E is for storing (i.e., writing) storage data in the recording layer 20 of the recording medium 18, and for reading stored memory data. The CD-R processing section 16E is structured by a motor 40, an optical pick-up 42, and a driving device 46. The motor 40 and the optical pick-up 42 are connected to the driving device 46, and the driving device 46 is connected to the control section 16A, such that transmission and receipt of data and commands therebetween is possible. The driving device 46 drives the motor 40 in accordance with the control of the control section 16A, and irradiates laser light of the optical pick-up 42 toward the recording layer 20. In this way, the CD-R processing section 16E can read and write data from and to the recording layer 20.

Next, operation of the present embodiment will be described.

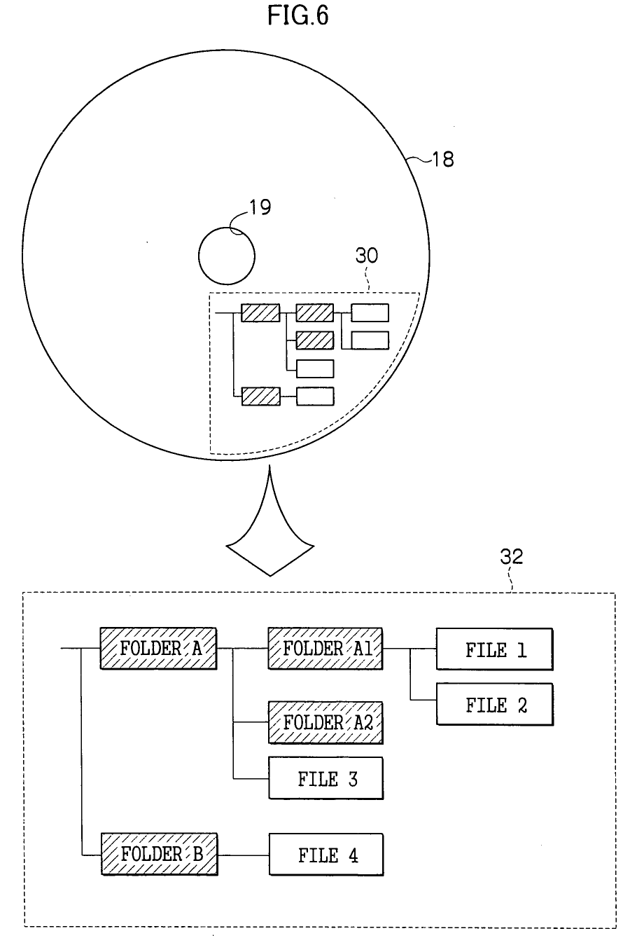

In the present embodiment, at the PC 12, storage data to be recorded onto the recording medium 18 is prepared by the user. The storage data may be stored in advance in the memory section 12D, or may be inputted from a storage medium such as a floppy (Trademark) disk or the like which is not illustrated. The storage data which is prepared by the user is written to the recording medium 18 loaded in the writing/reading device 16. Data based on the written storage data is displayed on the display section 12C. In the present embodiment, the storage data has, for example, a tree structure 32 such as that shown in FIG. 6. A display form 30 thereof is recorded in order to be able to be displayed on the indication layer 22.

In the present embodiment, description will be given of a case in which a CD-RW, at which data can be rewritten, is used as the recording layer 20 of the recording medium 18. Further, description will be given of a case in which the aforementioned electronic paper, at which data can be written by the irradiation of light, is used as the indication layer 22 of the recording medium 18.

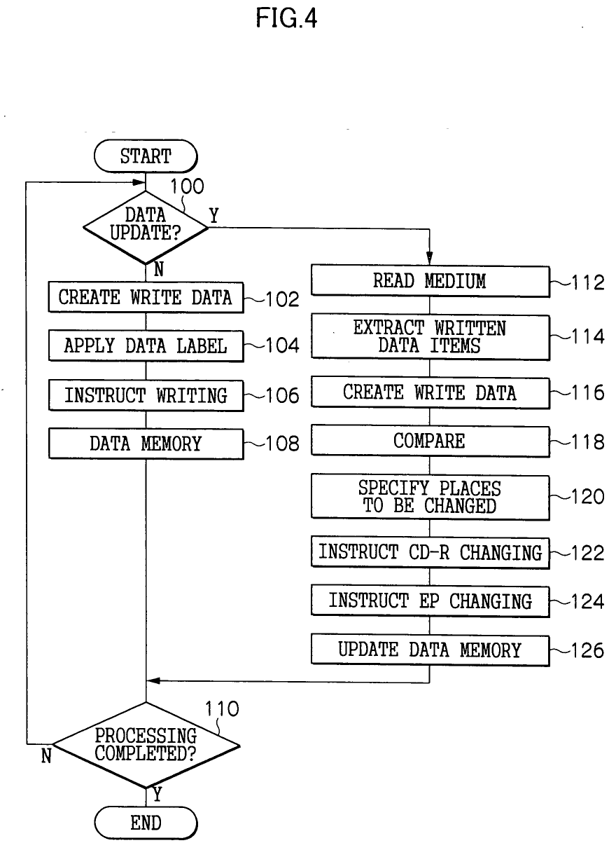

The processing routine executed at the PC 12 is illustrated in FIG. 4 in order to concretely explain the processings at the PC 12.

When power is supplied to the PC 12 by an unillustrated power switch of the PC 12 being turned on, the routine proceeds to step 100. In step 100, it is judged whether the data of the recording medium 18 is to be updated. This judgment is a judgment as to whether or not an instruction has been given to change the storage data, which the user has already stored on the recording medium 18, and again write storage data. In this judgment on the instruction to update the data, for example, menu items including items relating to updating of the storage data are displayed on the display section 12C. The user is urged to make an input with regard to the displayed menu item of whether or not there is to be an update of the storage data. It suffices for the judgment to be carried out by reading a data update instruction signal which is outputted at the time when an instruction to update the storage data is given by the operation section 12B.

When the judgment in step 100 is negative and there is not to be a data update, i.e., when storage data is to be newly written to the recording layer 20, the routine proceeds to step 102 where write data creating processing is carried out. Note that the determination in step 100 is negative also in cases in which there is a write instruction to rewrite all of the data at the recording layer 20. The write data creating processing is a processing in which storage data, which is to be stored at the recording layer 20, is extracted from the memory section 12D or a storage medium such as an unillustrated floppy (Trademark) disk or the like, and indication information is created from the extracted storage data.

In the extraction of the storage data, for example, a list of the memory data stored in the memory section 12D or the unillustrated storage medium is displayed on the display section 12C, and the user is urged to select the storage data to be stored in the recording layer 20. It then suffices for the memory data selected by the user operating the operation section 12B to be extracted as the storage data to be stored in the recording layer 20. At the time of this extraction, the relationships between the respective storage data (e.g., a tree structure) are also obtained.

The indication information is information to be displayed on the indication layer 22 and which relates to the extracted storage data. The indication information can indicate the storage data by a filename (filenames) or a serial number (serial numbers) or the like expressing the storage data (or the respective storage data). Then, the form in which the indication information is displayed on the indication layer 22 is selected.

The form of display may be, for example, the tree structure 30 of the storage data expressing the structure 32 of the storage data as shown in FIG. 6, or, it is possible for only the name(s) of the data to be expressed in one line, or the display may include a title and graphics. The form of display is selected, by the user operating the operation section 12B, from among one or plural forms set in advance. For example, menu items, for selecting a form in which the indication information is to be displayed on the indication layer 22, are displayed on the display section 12C. Then, the user is urged to make an input with respect to the displayed menu items, and it suffices to utilize the form of display which is inputted by the user operating the operation section 12B. The storage data (including the storage structure and position), the indication information, and the form of display are stored as write data in the RAM (not illustrated).

In subsequent step 104, data label applying processing is carried out. The data label applying processing is processing in which the write data, which is stored in the unillustrated RAM in step 102, is read out, and a data label which can be specified is applied to the storage data (a group of data formed from one or plural data) included in the write data which has been read-out. Namely, the data label is an identifier for uniquely identifying the numerical quantity, the type, the structure, and the like of the storage data. Examples include the date and time when the data label applying processing was carried out, the serial number, a value designated by the user, or the like. The applied data label is stored in the unillustrated RAM together with the corresponding storage data and indication information.

Note that the memory data can be specified by a title such as the file name of the memory data or the like. Accordingly, the relationship of correspondence of the write data can be created by generating a set file which specifies the memory data which is the object of writing by the file name, the stored position, or the structure (the relationship with other data or a directory or the like) of the memory data. Data expressing this set file (i.e., a title such as a file name or the like) may be used as the data label.

In subsequent step 106, write instructing processing is carried out. The write instructing processing is a processing for transmitting, to the writing/reading device 16, the write data corresponding to the data label, i.e., write instruction data for storing the storage data and the indication information in the recording medium 18. The write instruction data is structured so as to include the data label stored in the RAM, the storage data corresponding to that data label, the structure of the storage data, the indication information, the form of display, and the write instructing signal.

In step 106, the data is successively transmitted in order to store the storage data and the indication information in the recording medium 18, and in order to display the indication information on the recording medium 18. Due to the write instruction data, at the writing/reading device 16 which will be described later, the storage data and the indication information are stored in the recording layer 20 of the recording medium 18, and the indication information is written to the indication layer 22. This write instruction data is stored in the unillustrated RAM.

Therefore, even in a case in which the recording medium 18 is used at a PC other than the PC 12 which carried out the write instruction in above step 106, the indication information can be confirmed at the PC by reading the indication information stored in the recording layer 20 of the recording medium 18.

Note that, in the above-described writing instructing processing, the processing time, i.e., the time at which the write instruction data is transmitted to the writing/reading device 16, is read from an unillustrated built-in timer.

In subsequent step 108, the write instruction data to which the above data label is applied is stored in the storage section 12D as a record table. The record table includes, for the storage data formed from one or plural memory data and as stored items in units of memory data, a field storing the title or the storage position (directory) of the memory data, and a record formed by the indication information, the form of display, and the write time. The data label corresponds to this record. Accordingly, the record corresponding to the data label can be obtained by searching the record table by using the data label as an index.

Note that the data generated by the respective processings from step 102 through step 106 may be successively stored in the memory section 12D, and may be read out from the memory section 12D and subjected to processing as needed at the time of each processing.

When the processing of step 108 has been completed, the routine moves on to step 110 where it is judged whether or not processing has been completed. When the determination in step 110 is affirmative, the present routine ends. When the determination in step 110 is negative, the routine returns to step 100.

On the other hand, in a case in which an instruction to update the data has been given and the judgment in step 100 is affirmative, the routine moves on to step 112 where the data label and the indication information stored in the recording layer 20 are read. The read indication information and data label are stored in the unillustrated RAM.

In next step 114, written data item extracting processing is carried out. This written data item extracting processing is processing for grasping the storage data which has already been stored. The numerical quantity, type, and structure of the storage data, as well as the form of the indication information, are obtained from the record of the record table corresponding to the data label read in above step 112.

Further, the processings of steps 112 through 114 may be carried out on the basis of a data label input value inputted from the operation section 12B by the user, without reading out from the recording medium 18.

Or, the processings of steps 112 through 114 may be carried out by reading out, from the recording medium 18, the storage data in addition to the indication information and the data label, and obtaining, from the read-out storage data, the numerical quantity, the type, and the structure of the storage data as well as the form of the indication information.

Note that, at the time of carrying out the search in above step 114, a case in which no corresponding data label exists in the record table is a case in which a recording medium 18, which has no history of having been processed in the past, is loaded in the writing/reading device 16. In such a case, processing is to be newly carried out. Therefore, the routine may proceed to above step 102, in the same way as in the case in which the determination in above step 100 is negative.

In next step 116, write data creating processing in accordance with the substantial storage data for data updating is carried out. In this write data creating processing, write data is created by a read instruction or a delete instruction for the storage data (memory data) to be updated. For example, the list of file names of the storage data corresponding to the data label read in above step 112 is displayed, and the user is urged to indicate the files to be changed, i.e., added, deleted, updated, or the like. Then, the title of the memory data or the structure of the storage data indicated by the operation of the user is stored in the unillustrated RAM.

At the point in time when step 116 is completed, the setting of all of the memory data, which includes the changes from the storage data written to the recording medium 18 the previous time, and the data related thereto, is completed. Namely, maintaining of storage, deleting, adding, changing of contents, or the like is set for each of the memory data.

In next step 118, the write data created in above step 116 and the storage data corresponding to the data label read in above step 112 are compared. From the results of this comparison, in step 120, the places to be changed of the storage data and the indication information to be recorded in the recording layer 20 of the recording medium, and of the indication information to be written at the indication layer 22, are specified. The places to be changed are expressed by the data for changing the storage data, i.e., the numerical quantity, types, structure, and indication information of the storage data, as well as the form of the indication information. The places to be changed are stored in the unillustrated RAM.

In step 120, among the memory data included in the storage data written to the recording medium 18 the previous time, the memory data other than that which is to remain stored, i.e., the memory data to be deleted or written or the like, are specified, and the positions (and structures) thereof are specified, and the differences are generated as update data. In this way, the portions corresponding to the updating of data from the previous time can be extracted. In the same way, among the data included in the indication information written to the recording medium 18 the previous time, the data other than that which is to remain displayed, i.e., the indication information to be deleted or added or the like, are specified, and the positions (and structures) thereof are specified, and the differences are generated as indication information to be updated.

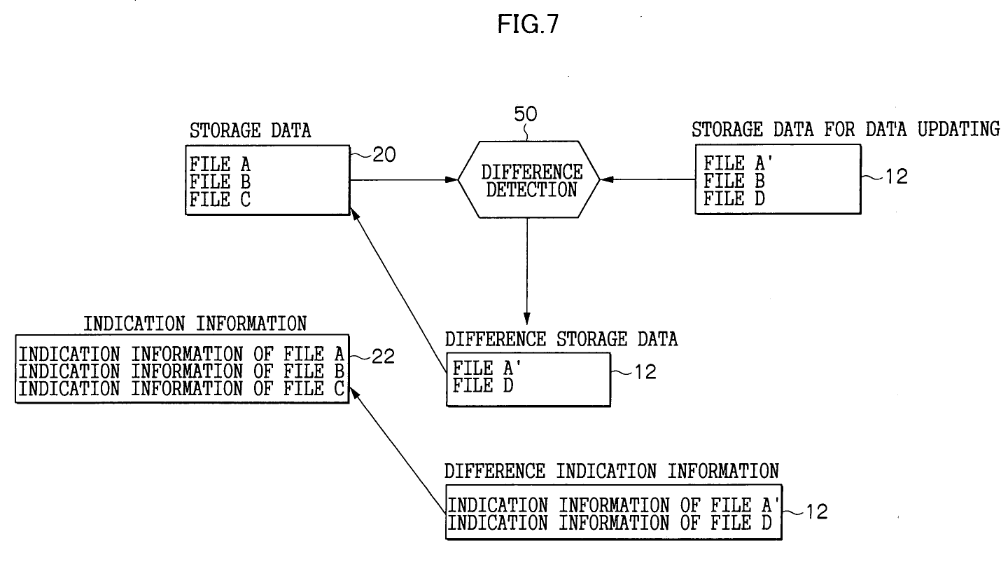

Here, a typical example of an addition in the processings of steps 118 and 120 will be described. FIG. 7 schematically illustrates a process of comparing the storage data stored in the recording medium 18 and the storage data which is to be subsequently stored (the storage data for updating the data), and specifying the places to be changed. In this example, file A, file B and file C are stored in the recording layer 20 as storage data. Further, indication information of file A, indication information of file B, and indication information of file C are displayed at the indication layer 22 as indication information. Moreover, file A′, file B and file D are prepared at the PC 12 as storage data to be newly stored.

First, in a difference detecting processing section 50 corresponding to step 118, the storage data stored in the recording layer 20 and the storage data for data updating which has been prepared at the PC 12 are compared, and difference detecting processing which detects the differences between these data is carried out. In this difference detecting processing, it is judged whether or not a file which has already been stored as storage data exists in the storage data for data updating. In this example, because file B has already been stored, file A′ and file D are specified as files to be newly stored (difference storage data).

When a file to be newly stored is specified, on the basis of the specified file, difference storage data, which corresponds to the update data for updating the storage data, and difference indication information, which corresponds to the indication information for updating the indication information, are generated. In this example, file A′ and file D are generated as the difference storage data. Indication information of file A′ and indication information of file D are generated as difference indication information.

Note that this example describes a case of the addition of a file included in the storage data and the indication information. However, a file included in the storage data and the indication information may be deleted.

In subsequent step 122, CD-R change instructing processing is carried out. In the CD-R change instructing processing, CD-R change instructing data, which are the changed portions of the storage data and the indication information of the recording medium 18 among the places to be changed which were specified in above step 120, are transmitted to the writing/reading device 16. The CD-R change instructing data is structured so as to include the place to be changed, the update data, the change indication information, and the CD-R write instructing signal. The update data corresponds to the title of the memory data or the structure of the storage data created in above step 116. Due to this CD-R change instructing signal, at the writing/reading device 16 which will be described later, changing of the indication information and the storage data stored at the recording layer 20 of the recording medium 18 is carried out.

In next step 124, EP (electronic paper) change instructing processing is carried out. In this EP change instructing processing, EP change instruction data, which is for changing, in accordance with the change (update) of the aforementioned storage data, the indication information written at the indication layer 22, is transmitted to the writing/reading device 16. This EP change instruction data is structured so as to include change indication information and an EP write instructing signal. The EP change instruction data corresponds to the changed portions of the indication information, among the changed places to be changed which were specified in above step 120. At the writing/reading device 16 which will be described later, the EP change instruction data is displayed at the indication layer 22.

Next, in step 126, the record table stored in the memory section 12D is updated, and the routine moves on to step 110. Step 126 is processing for, on the basis of the places to be changed, updating the record corresponding to the data label. Updating is carried out by modifying, deleting, or adding respective fields of the record recorded the previous time. For example, the title of the memory data, the stored position (directory), the indication information, the form of display, the writing time, or the like are updated. Accordingly, the record table is updated to the most recent state each time data updating is carried out.

Note that the various types of data extracted or generated in the processings from step 112 through step 124 may be stored in the storage section 12D each time processing is carried out, and successively read out.

The processing of above step 118 corresponds to the function of the detecting section of the writing/reading device of the present invention. The processing of above step 120 corresponds to the function of the generating section of the present invention. The processings of steps 122 through 124 correspond to the function of the control section of the present invention. Further, the processings of steps 108 and step 126 correspond to the function of the memory section of the present invention.

Next, the processing of writing data to the recording medium 18 at the writing/reading device 16 will be described.

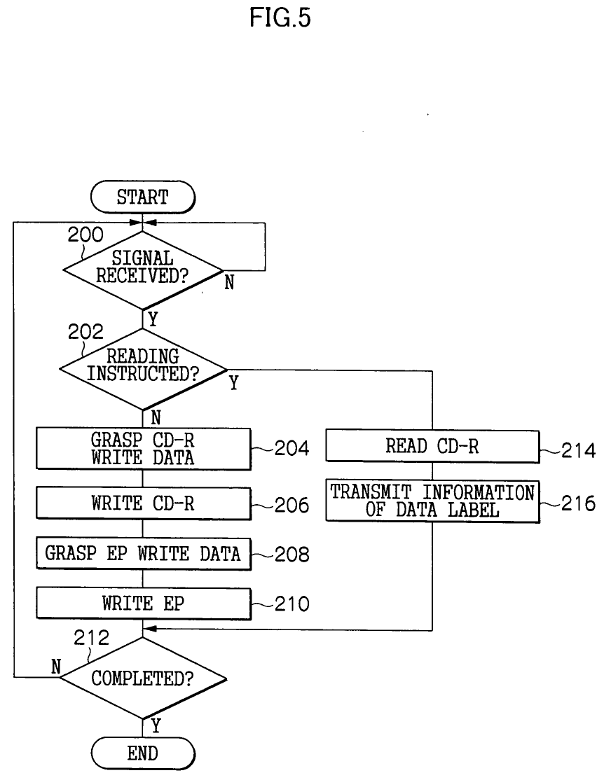

When the power of the writing/reading device 16 is turned on and the recording medium 18 is loaded therein, the processing routine shown in FIG. 5 is executed, and the routine proceeds to step 200. In step 200, a negative determination is repeated until a signal is received from the PC 12. When the determination is affirmative, the routine moves on to step 202. In step 202, a judgment is made as to whether or not the received signal is a data label read signal. If the received signal is not an instruction to read a data label, the routine moves on to step 204 where CD-R write data grasping processing is carried out.

In step 204, the indication information and the storage data for writing in the recording layer 20 of the recording medium 18 are grasped from the received signal. The storage data, the structure of the storage data, and the indication information are grasped. In this step 204, there is grasping in cases in which storage data and indication information are to be newly stored, and grasping in cases in which storage is to be carried out in order to update already-stored storage data and indication information. In the case of new storage, processing is carried out in succession on all of the data in order to write all of the storage data and the indication information in accordance with the aforementioned write instruction. On the other hand, in the case of storing in order to update, the deletions or changes with respect to the storage data and the indication information which have already been stored, or the additions of memory data are grasped, and the routine moves on to the next processing.

In subsequent step 206, the indication information and storage data (including the structure of the storage data) which were grasped in above step 204 are written to the recording layer 20. In this step 206, the motor 40 and the optical pick-up 42 are driven by the driving device 46, and the storage data and the indication information are stored at the recording layer 20 by laser light from the optical pick-up 42. Accordingly, in the case of new storage, all of the storage data and the indication information are written, and in the case in which updating is carried out, addition, changing, deletion or the like is carried out for the corresponding places.

In next step 208, EP write data grasping processing is carried out. This EP write data grasping processing is processing for extracting, from the received signal, the indication information and the form of display, or the change indication information and the form of display, for displaying on the indication layer 22. In the same way as in above step 204, there are the following two types of grasping in this step 208: grasping in the case of new storage and grasping in the case of updating. In the case of new storage, the routine moves on to the next process for writing all of the indication information to the indication layer 22. In the case of updating, processings are carried out in succession in order to write to the instructed places to be changed.

In subsequent step 210, the grasped indication information is written to the indication layer 22 on the basis of the form of display. In the EP writing processing which writes the indication information to the indication layer 22, the indication information is displayed at the switching element 32, and light is irradiated from the light source 30, and an image expressing the indication information displayed on the switching element 32 is irradiated onto the indication layer 22 via the lens 34. Accordingly, in the case of new storage, all of the indication information is written, and in the case in which updating is carried out, adding, changing, deleting or the like is carried out for the corresponding places.

When the processing of step 210 has been completed, the routine moves on to step 212 where it is judged whether processing is completed. If the determination is affirmative, the present routine ends. If the determination is negative, the routine returns to step 200.

On the other hand, if the judgment in above step 202 is affirmative and there is a media read instruction from the PC 12, the routine moves on to step 214 where the data label and the indication information stored at the recording layer 20 of the recording medium 18 are read. In next step 216, the read data label and indication information are transmitted to the PC 12, and thereafter, the routine moves on to step 212.

As described above, in the present embodiment, storage data is written to the recording layer 20 of the recording medium 18, and indication information, which enables the storage data stored at the recording layer 20 to be easily grasped, is written to the indication layer 22 laminated on the recording medium 18. Accordingly, it is possible to easily and correctly grasp the storage data stored at the recording layer 20 by the indication information displayed at the indication layer 22.

Note that the processing of above step 206 corresponds to the function of the storing section of the writing/reading device of the present invention, and the processing of step 210 corresponds to the function of the writing section of the present invention.

Further, the present invention is not limited to the above-described embodiment. For example, the present embodiment describes a case in which the present invention is applied to the writing/reading system 10 which is structured by the PC 12 and the writing/reading device 16. However, an integral structure in which the functions of the writing/reading device 16 are provided at the PC 12 may be used.

Moreover, the present embodiment describes a structure in which an optical recording medium is laminated on a CD-RW which serves as the recording medium 18. However, a CD-R, a DVD or the like may be used as the recording medium 18.

In addition, in the present embodiment, the indication layer 22 which indicates data by the irradiation of light is described. However, it is possible to form and use the recording medium 18 on which a different indication material, to which data can be written or from which data can be deleted, is laminated as the indication layer 22. The processing mechanisms for writing, deleting, and the like with respect to the indication layer 22 in this case may be formed in accordance with the characteristics of that indication material.

As described above, in accordance with the recording medium and the writing/reading device of the present invention, storage data is written to a storage layer of a recording medium at which the storage layer and an indication layer are laminated, and indication information expressing the contents of the storage data is written to the indication layer. Therefore, it is possible to easily and correctly grasp the storage data which is stored at the recording medium.

What is claimed is:

1. A recording medium comprising a storage layer for storing data, and an indication layer for providing indication information relating to the stored data, wherein the indication information can be written at the indication layer, and at least a portion of the indication information which has been written can be rewritten.

2. The recording medium of claim 1, wherein the indication layer includes electronic paper.

3. The recording medium of claim 1, wherein the indication layer has a cholesteric layer and a transparent electrode layer on a light absorbing layer.

4. The recording medium of claim 1, wherein the indication information is written by irradiating light in a form of an image onto the indication layer.

5. The recording medium of claim 1, wherein the indication layer has a heat recording layer at which the indication information can be recorded and deleted by a heat treatment.

6. A data writing device writing data to a recording medium having a storage layer for storing data, and an indication layer for providing indication information relating to the stored data, the device comprising:
a storing section storing data at the storage layer of the recording medium; and
a writing section writing, at the indication layer, the indication information which relates to the stored data and which is for indication at the recording medium.

7. The data writing device of claim 6, wherein the indication information can be written at the indication layer, and at least a portion of the indication information which has been written can be rewritten.

8. The data writing device of claim 6, wherein the indication layer includes electronic paper.

9. The data writing device of claim 6, wherein the storing section also stores the indication information at the storage layer.

10. The data writing device of claim 6, further comprising a data memory section for storing the stored data and the indication information.

11. The data writing device of claim 6, further comprising:
a detecting section detecting a difference between storage data which is stored at the storage layer of the recording medium, and new data which is to be subsequently stored; and
a generating section which, on the basis of results of detection of the detecting section, generates detection data regarding the difference between the data stored at the storage layer and the new data which is to be subsequently stored, and generates indication information which corresponds to the difference,
wherein the storing section stores, at the storage layer, the detection data regarding the difference, and the writing section writes, at the indication layer, the indication information which corresponds to the difference.

12. The data writing device of claim 11, wherein the indication information can be written at the indication layer, and at least a portion of the indication information which has been written can be rewritten.

13. The data writing device of claim 11, wherein the indication layer includes electronic paper.

14. The data writing device of claim 11, wherein the storing section also stores, at the storage layer, the indication information which corresponds to the difference.

15. The data writing device of claim 11, further comprising a data memory section storing the stored data and the indication information which corresponds to the difference between the data stored at the storage layer and the new data.
